(19) United States
(12) Patent Application Publication
(10) Pub. No.: US 2009/0152418 A1
(43) Pub. Date: Jun. 18, 2009

(54) PORTABLE ELECTRONIC DEVICE HOLDER, ESPECIALLY FOR A DASHBOARD OF A CAR

(75) Inventor: Henryk BURY, Mielec (PL)

Correspondence Address: MATTHIAS SCHOLL, 14781 MEMORIAL DRIVE, SUITE 1319, HOUSTON, TX, 77079, US

(73) Assignee: BURY Sp z o.o., Mielec (PL)

(21) Appl. No.: 12/275,390

(22) Filed: Nov. 21, 2008

(30) Foreign Application Priority Data
Dec. 12, 2007 (EP) 07460037

(51) Int. Cl. B60N 3/00

(52) U.S. Cl. 248/205.3; 248/205.1

(57) ABSTRACT

A portable electronic device holder, especially for the dashboard of a car, comprising: a base (1) having a lower plate (2), and a cavity (4); and a console (5) having a mounting plate (7) with a shaft (8), and a motor (28) for rotating said mounting plate (7); wherein said console (5) is adapted to be inserted into said cavity (4); said lower plate (2) has a shape adapted to a shape of a dashboard (3) of a car and is detachably fixed thereto; and said mounting plate (7) sits rotatably in the console (5) and is adapted for mounting a portable device (11).

### CROSS-REFERENCE TO RELATED APPLICATIONS

This application claims priority to the European Patent Application No. EP07460037 filed Dec. 12, 2007, the contents of which are incorporated herein by reference.

### BACKGROUND OF THE INVENTION

1. Field of the Invention

This invention relates to a portable electronic device holder, especially for a dashboard of a car, provided with a mounting plate, which plate sits rotatably in the holder and to which the portable device is mounted.

2. Description of the Related Art

German utility model 20313215 discloses a holder for mounting a device, especially in a car, which includes a suction cup mounted to a smooth surface within the car and a mounting plate that is attached to the suction cup with a hinged joint to which the device is to be mounted. On the external surface of the holder there is a button to mount the suction cup and handwheels to adjust the angle, at which the device has to be mounted to the dashboard of the car. The holder is also provided with an additional mount, which enables fixing the holder to a desired surface within a car.

WO 2007/100239 A1 describes a navigation device and the method to mount it within a car. This device includes a base that ends with a suction cup or is inserted into a hole made, e.g., in the dashboard of a car and a mounting arm, which sits rotatably in the said base and accommodates a navigation device, whereas the said arm is slideably supported on a curved block to enable setting a desired angle, at which the navigation device is inclined to the horizontal plane.

German utility model 29707123 describes a holder for mounting various devices within a car. The said holder includes a first plate mounted to a desired surface within a car by mean of screws and a mounting plate, which is attached to the first plate with articulated arms. The device, e.g. a mobile phone, is mounted to the mounting plate.

A similar device for mounting a mobile phone within a car is disclosed by the U.S. Pat. No. 5,187,744 and U.S. Pat. No. 6,315,255.

A major inconvenience of portable electronic device holders with suction cups, as known in the art, is that such holders do not ensure a firm mounting to a smooth surface within a car since in most cases these surfaces show a certain degree of roughness. On the other hand, other holders used for this purpose need affecting the integrity of the surface within a car, to which the holder is mounted, for example by drilling holes to mount the base of the holder or to drive screws into it. Accordingly, much opportunity for improvement exists in this technological area.

### BRIEF SUMMARY OF THE INVENTION

It is an objective of the invention to provide a holder for mounting portable electronic devices, especially to a dashboard of a car, which will not affect the integrity of the dashboard, will enable positioning the electronic device at a desired angle from the horizontal plane, as well as it should allow mounting portable electronic devices of a large size, e.g., navigation devices with a conveniently big display, set at a desired angle from the horizontal plane.

In one embodiment of the invention provided is a holder for mounting portable electronic devices, especially to the dashboard of a car. The holder is provided with a base with a lower plate, which shape is adapted to that of the dashboard of a car, the base having a cavity to accommodate a console, to which a mounting plate with a motor is attached rotatably and axially. The electronic device is mounted to the mounting plate. The bottom surface of the base is detachably glued to the dashboard of a car, for example, by means of a double-side silicone adhesive tape.

In a class of this embodiment, the holder console is provided with a frame inserted into the cavity in the base and accommodating the shaft of the mounting plate, and the space between the arms of the frame allows placing the portable electronic device in it.

In a class of this embodiment, the console is provided with protrusions, and the base is provided with holes (or vice versa) so that the protrusions may be clamped in the holes.

In a class of this embodiment, the mounting plate of the holder is favourably provided with a coil return spring and a hydraulic mechanism to slow down the rotation of the mounting plate.

In a class of this embodiment, the hydraulic slow-down mechanism comprises a casing, which is rotatably mounted on the shaft, connected to the mounting plate and covered with a lid and filled with a high-viscosity lubricant, and of a multiple-blade rotor keyed on the shaft of the mounting plate.

In a class of this embodiment, the base of the holder is favorably provided with a hole, through which the electric wires, connecting the holder to the car wiring system, may be drawn.

In a class of this embodiment, the holder console is favorably provided with an antenna, especially a TMC antenna, installed in the frame.

In a class of this embodiment, the holder base is favorably made of resilient plastic.

In a class of this embodiment, the mounting plate is favorably provided with a first catch, which is adapted to engage with a corresponding slot in the electronic device to be mounted to the mounting plate, and with a second catch, located at its circumference, which is adapted to engage with a corresponding catch of the button in the base.

In a class of this embodiment, the console of the holder is favorably provided with a limiter connected to a handwheel to limit the rotation of the mounting plate.

The performance tests of the holder, according to the invention, revealed its universality since the holder not only may accommodate any device, even large-size electronic ones, especially navigation devices with displays, but also it allows hiding these devices inside the holder when it is in the closed position.

Moreover, the holder may be installed without cutting or drilling holes in the surface within a car, especially in the dashboard, its assembly is easy and can be performed by the user without any tools.

### BRIEF DESCRIPTION OF THE DRAWINGS

The portable electronic device holder, especially for the dashboard of a car, according to the invention, is depicted on the drawings attached, in which:

FIG. 1 shows a holder in the locked position, glued to the dashboard of a car according to one embodiment of the invention;

FIG. 2 is an exploded view of the holder according to one embodiment of the invention;

FIGS. 3 and 4 depict the particular phases of mounting the navigation device to the mounting plate of the holder according to one embodiment of the invention;

FIG. 5 shows the holder in the locked position with a navigation device sitting in it, according to one embodiment of the invention;

FIG. 6 shows the arrangement of the wiring connecting the holder to the car wiring system according to one embodiment of the invention;

FIG. 7 shows the position of an antenna, especially a TMC antenna, in the holder according to one embodiment of the invention;

FIG. 8 shows the holder with the mechanism, which releases the mounting plate with the motor, according to one embodiment of the invention;

FIG. 9 shows another embodiment of the invention having a hydraulic slow-down mechanism, which opens the mounting plate and limits its rotational motion; and

FIG. 10 is an expanded view of a hydraulic slow-down mechanism.

### DETAILED DESCRIPTION OF THE INVENTION

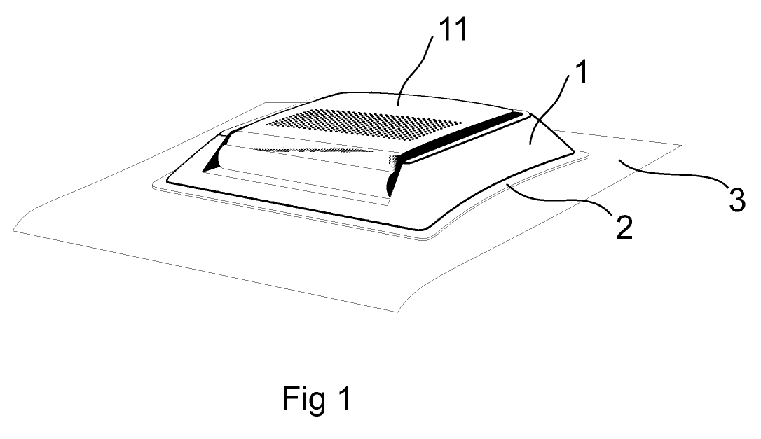

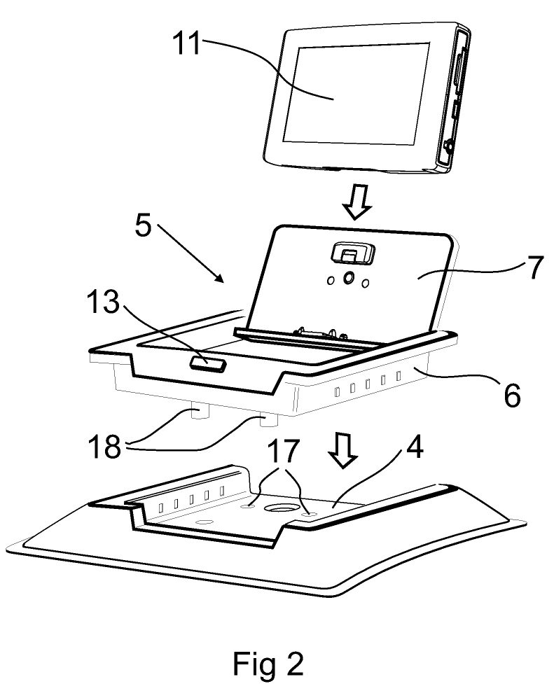

The portable electronic device holder, as depicted in the FIGS. 1 and 2, used for example to mount a navigation device to the dashboard of a car, comprises: a base 1 with a lower plate 2 which has a shape adapted to the shape of the dashboard 3 of a car and is favorably attached to the dashboard with a double-sided silicon adhesive tape, and is provided with a cubicoid cavity 4, into which a console 5 is inserted.

The base 1 is conveniently made of a resilient plastic, e.g. a polyvinyl chloride. The console 5 comprises a frame 6 inserted into the cavity 4 in the base 1 and of a mounting plate 7, which sits rotatably in the frame and is provided with a motor to make it rotate, whereas the space between the frame arms 8 allows placing a portable electronic device 11 in it, mounted to the mounting plate 7.

The mounting plate 7, sitting rotatably on the shaft 8, is provided with a plug 9, located in the nearby of the shaft, and a catch 10, which is adapted to engage with a corresponding slot in the electronic device 11, to mount it and to lock it in the mounting plate. On the shaft 8 of the mounting plate 7 there is mounted a motor 28 with a gear to make the mounting plate rotate. The motor 28 is controlled by an electronic module 29, which is activated when the button 13 in the frame 6 is pressed; however, the motion direction depends on the position of the mounting plate 7, i.e., on the position of motor limit switches, not shown on the drawing.

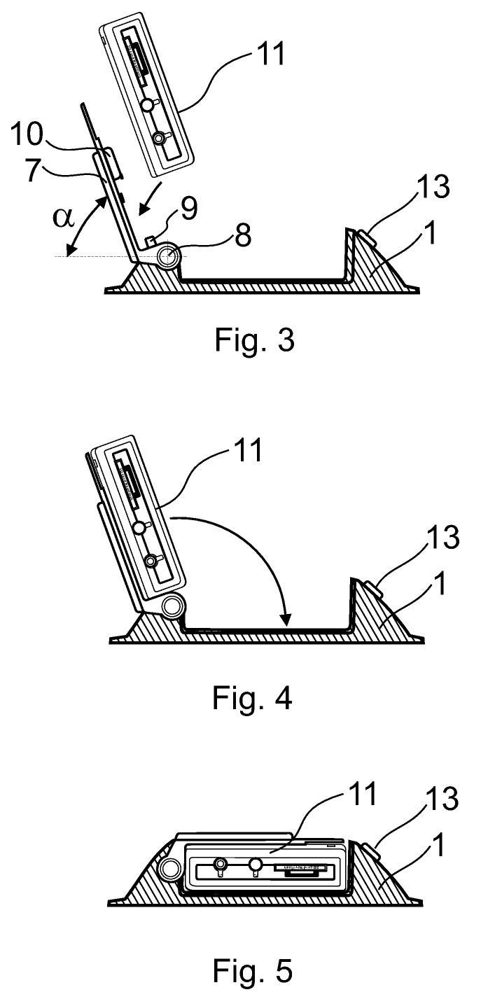

FIGS. 3 to 5 show a method of mounting the electronic device 11, for example a navigation device, in the mounting plate 7. The device 11 moves across the mounting plate 7, its slot is driven onto the plug 9 and then is pressed down towards the mounting plate 7, which results in that the catch 10 engages with a corresponding slot in the base of the device 11 and locks it in a set position. To close the mounting plate 7 with the electronic device 11 in it, it is necessary to push the button 13, which activates the electronic module 29 controlling the motor 28 (FIG. 8). To open the mounting plate 7 it is necessary to push the button 13 again.

When open, the mounting plate is inclined to the horizontal plane at a set a angle. To set the a angle, a limiter of the rotation of the mounting plate 7 is used, connected with the handwheel 16.

In order to mount the console 5 firmly, the base 1 is provided with holes 17 and the console is provided with protrusions 18, which are clamped in these holes (or vice versa).

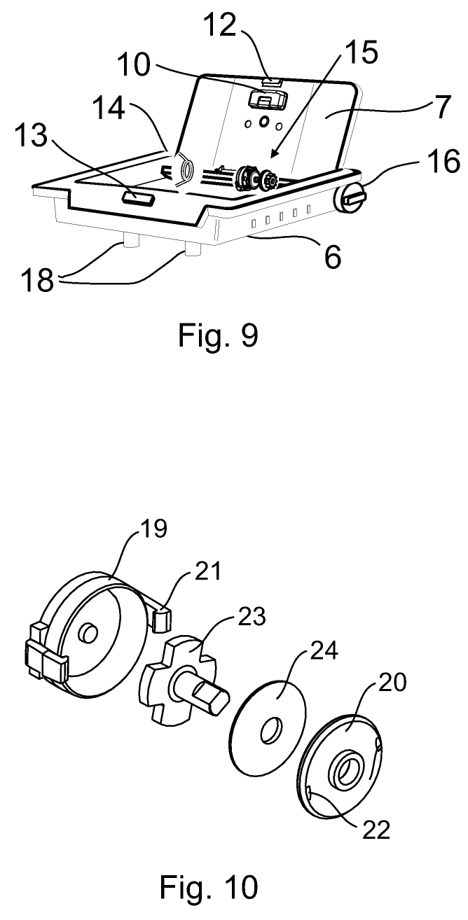

In another embodiment, as depicted on the FIG. 9, to close and open the mounting plate 7 manually, there is provided a hydraulic slow-down mechanism 15, connected to the mounting plate, and the catch 12 engages with the button 13 of the frame 6. In order to close the mounting plate, it can be rotated manually around the shaft 8 and the catch 12 engages with the corresponding slot of the button 13, thus closing the holder. To open the mounting plate 7 with the electronic device 11 in it, it is necessary to push the button 13 to release the catch 12 and the coil return spring 14 makes the mounting plate 7 rotate, slowed down by the hydraulic mechanism 15 and thus opens the mounting plate 7.

The hydraulic slow-down mechanism, as depicted in the FIG. 10 in an exploded view, comprises a casing 19, which is connected to the mounting plate 7, sits rotatably on the shaft 8 of the mounting plate 7 and is provided with catches 21 that are adapted to engage with the slots 22 in the cover 20. The space inside the casing 19 is filled with a high-viscosity lubricant, in which a multiple-blade rotor 23 rotates, keyed on the shaft 8. The gasket 24 is provided to seal the casing 19.

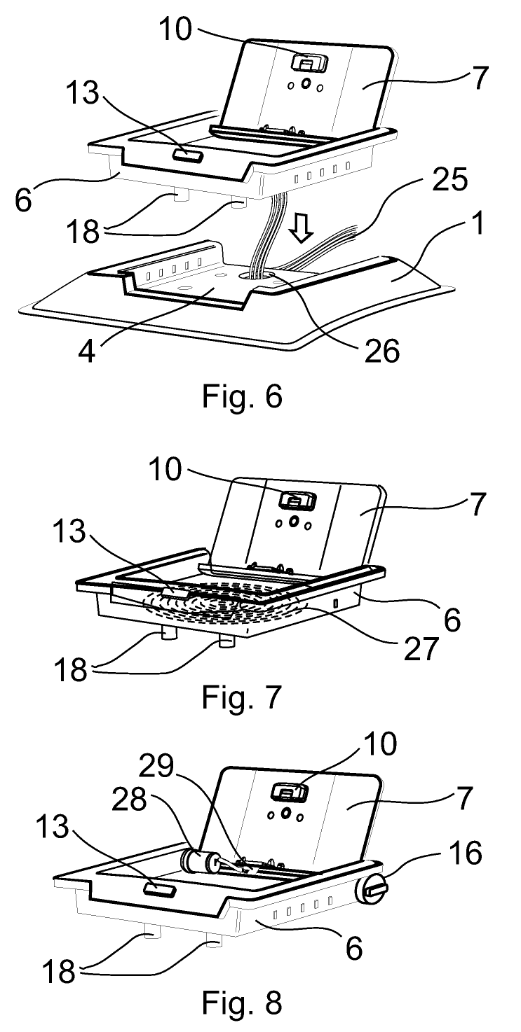

FIG. 6 shows the arrangement of the wiring 25, which connects the holder and the wiring system of the car. The hole 26 is provided in the holder base 1 to drive the wiring through it.

FIG. 7 shows the arrangement of an antenna, especially a TMC antenna 27, within the console 5 of the holder.

Assembling the holder, according to the invention, and mounting it to the external surface of the dashboard 3 of a car comprises removing the paper protective strip from the double-sided silicone adhesive tape and pressing the base 1 to the surface of the dashboard 3. Then, the wiring 25 is driven through the hole 26 in the base 1 and connected to the relevant cables in the car wiring system. Next, the console 5 is pressed down so that its protrusions 18 move into the slots 17 in the base 1. Then, the desired portable electronic device 11 is mounted to the mounting plate as described above. When the car is not moving it is useful to close the mounting plate 7 to a position as shown in the FIG. 5, so that the device is hidden completely.

Opening or closing the holder with a motor, according to the invention, may be executed automatically by turning the key in the ignition switch, which electric system controls the electronic module 29.

The holder, according to the invention, may be used in various types of cars, which may require replacing the base 1 with the one fitting to the shape of the dashboard in a particular car. To make the replacement it is necessary to remove the base 1 from the dashboard and a new base is glued to the dashboard with a double-sided adhesive tape.

This invention is not to be limited to the specific embodiments disclosed herein and modifications for various applications and other embodiments are intended to be included within the scope of the appended claims. While this invention has been described in connection with particular examples thereof, the true scope of the invention should not be so limited since other modifications will become apparent to the skilled practitioner upon a study of the drawings, specification, and following claims.

All publications and patent applications mentioned in this specification are indicative of the level of skill of those skilled in the art to which this invention pertains. All publications and patent applications mentioned in this specification are herein incorporated by reference to the same extent as if each individual publication or patent application mentioned in this specification was specifically and individually indicated to be incorporated by reference.

The invention claimed is:

1. A portable electronic device holder, especially for the dashboard of a car, comprising:
a base (1) having a lower plate (2), and a cavity (4); and
a console (5) having a mounting plate (7) with a shaft (8), and a motor (28) for rotating said mounting plate (7);
wherein
said console (5) is adapted to be inserted into said cavity (4);
said lower plate (2) has a shape adapted to a shape of a dashboard (3) of a car and is detachably fixed thereto; and
said mounting plate (7) sits rotatably in the console (5) and is adapted for mounting a portable device (11).

2. The holder of claim 1, wherein said lower plate (2) is fixed to the dashboard (3) with a double-sided silicone adhesive tape.

3. The holder of claim 1, wherein said console (5) is provided with a frame (6) having arms inserted into said cavity (4) to accommodate said shaft (8), whereas space formed between said arms of the frame is adapted for holding a portable electronic device.

4. The holder of claim 1, wherein said console (5) is provided with protrusions (18), and said base (1) is provided with holes (17), so that said protrusions (18) may be clamped in said holes (17).

5. The holder of claim 1, wherein said mounting plate (7) comprises further a coil return spring (14) and a hydraulic slow-down mechanism (15) filled with a high-viscosity lubricant, whereby said mounting plate is rotated.

6. The holder of claim 1, wherein said base (1) comprises further a hole (26) for accommodating electric wires (25) connecting the holder (1) to a car wiring system.

7. The holder of claim 1, wherein said console (5) comprises further an antenna installed in said frame (6).

8. The holder of claim 7, wherein said antenna is a TMC antenna (27).

9. The holder of claim 1, wherein said base (1) is made of resilient plastic.

10. The holder of claim 1, wherein said mounting plate (7) is provided with a first catch (10), said first catch (10) being adapted to engage with a corresponding slot in an electronic device (11) to be mounted to said mounting plate, and with a second catch (12), located at a circumference of said mounting plate (7), said second catch (12) being adapted to engage with a corresponding third catch (13), said third catch being disposed on said base (1).
